(19) United States
(12) Patent Application Publication
(10) Pub. No.: US 2024/0213551 A1
(43) Pub. Date: Jun. 27, 2024

(54) ELECTROCHEMICAL DEVICE

(71) Applicant: Panasonic Intellectual Property Management Co., Ltd., Osaka (JP)

(72) Inventors: NOBUTAKA TAKEDA, Osaka (JP); KENICHI NAGAMITSU, Kyoto (JP); HIDEO SAKATA, Osaka (JP)

(21) Appl. No.: 18/546,965

(22) PCT Filed: Feb. 22, 2022
(86) PCT No.: PCT/JP2022/007216

§ 371 Date: Aug. 17, 2023

(30) Foreign Application Priority Data
Feb. 25, 2021 (JP) 2021-029064

(51) Int. Cl. H01M 10/42; H01G 11/28; H01G 11/34; H01G 11/62; H01M 4/133; H01M 4/587; H01M 10/052; H01M 10/0568; H01M 4/02

(52) U.S. Cl. CPC H01M 10/4235; H01G 11/28; H01G 11/34; H01G 11/62; H01M 4/133; H01M 4/587; H01M 10/052; H01M 10/0568; H01M 2004/021; H01M 2004/027; H01M 2300/0037

(57) ABSTRACT

An electrochemical device includes a positive electrode, a negative electrode, and an electrolyte having lithium ion conductivity. The negative electrode includes a negative current collector and a negative electrode material layer supported on the negative current collector. The negative electrode material layer contains a negative electrode active material capable of being reversibly doped with lithium ions. The negative electrode active material contains a carbon material. The negative electrode material layer includes a coating region on a surface layer portion of the negative electrode material layer. An O1s spectrum for the coating region has a peak in a range from 530 eV to 534 eV of a binding energy in an O1s spectrum. An intensity of the peak in the O1s spectrum increases as a measuring position changes from a surface layer of the coating region toward the inside of the coating region.

### TECHNICAL FIELD

The present invention relates to an electrochemical device.

### BACKGROUND

Electrochemical devices using a carbon material that absorbs lithium ions for a negative electrode material layer are known (see PTLs 1 to 3). The electrochemical device includes a positive electrode, a negative electrode, and an electrolyte. As an electrolyte having lithium ion conductivity, an electrolytic solution obtained by dissolving a lithium salt such as LiPF₆ in a nonaqueous solvent is known.

PTL 4 proposes a lithium ion capacitor having an electrolytic solution that contains a mixture of lithium bis(fluorosulfonyl)imide (LiFSI) and LiBF₄, a solvent containing at least one cyclic or chained carbonate compound, and a film-forming agent, in which a molar ratio of LiFSI to LiBF₄ is 90/10 to 30/70, and a concentration of the mixture in the electrolytic solution is 1.2 mol/L to 1.8 mol/L.

### Citation List

### Patent Literature

PTL 1: Unexamined Japanese Patent Publication No. 2014-123641

PTL 2: International Publication WO 2007/88604

PTL 3: International Publication WO 2012/036249

PTL 4: Unexamined Japanese Patent Publication No. 2017-216310

### SUMMARY

In an electrochemical device using lithium ions, a solid electrolyte interface coating film (that is, an SEI coating film) is formed on a negative electrode material layer during charging and discharging. The SEI coating film serves an important function in charging and discharging reaction, but if the SEI coating film is formed excessively thick, the internal resistance of the electrochemical device increases.

In an electrochemical device using lithium ions, lithium ions are pre-doped in the negative electrode in advance before charging and discharging. The pre-doping is performed, for example, by immersing the negative electrode in an electrolytic solution containing lithium ions and applying a voltage to the negative electrode. In this case, the SEI coating film contains LiF as a main component. The SEI coating film containing LiF as a main component is stable to an electrolytic solution, but has high resistance.

When an electrolyte obtained by dissolving a phosphate containing fluorine such as LiPF₆ is used, LiPF₆ has high reactivity with water and is easily decomposed. The decomposition produces HF. The produced HF disintegrates the SEI coating film. Therefore, it is difficult to form a high-quality SEI coating film, and the internal resistance of the device tends to be high.

On the other hand, when an electrolyte obtained by dissolving LiFSI is used, LiFSI hardly reacts with water, and HF is hardly generated. However, an SEI coating film containing LiF as a main component is easily formed, and the internal resistance of the device increases.

An aspect of the present invention relates to an electrochemical device including: a positive electrode; a negative electrode; and an electrolyte having lithium ion conductivity, in which the negative electrode includes a negative current collector and a negative electrode material layer supported on the negative current collector. The negative electrode material layer contains a negative electrode active material capable of being reversibly doped with lithium ions. The negative electrode active material contains a carbon material. The negative electrode material layer includes a coating region on a surface layer portion of the negative electrode material layer. When the coating region is measured by X-ray photoelectron spectroscopy, a peak is observed in a range from 530 eV to 534 eV of a binding energy in an O1s spectrum, and an intensity of the peak in the O1s spectrum increases from a surface layer of the coating region toward the inside of the coating region.

According to the present invention, the electrochemical device suppresses an increase of an internal resistance.

### BRIEF DESCRIPTION OF THE DRAWINGS

FIG. 1 is a longitudinal cross-sectional view illustrating a configuration of an electrochemical device according to an exemplary embodiment of the present invention.

FIG. 2 is a graph showing changes in a peak intensity A at an apex of a peak attributed to a lithium carbonate bond of an O1s spectrum, a peak intensity B at an apex of a peak of an F1s spectrum, and a peak intensity ratio A/B in a depth direction in an electrochemical device of Example 1.

FIG. 3 is a graph showing changes in a peak intensity A at an apex of a peak attributed to a lithium carbonate bond of an O1s spectrum, a peak intensity B at an apex of a peak of an F1s spectrum, and a peak intensity ratio A/B in a depth direction in an electrochemical device of Comparative example 1.

### DESCRIPTION OF EMBODIMENT

An electrochemical device according to an exemplary embodiment of the present invention includes a positive electrode, a negative electrode, and an electrolyte having lithium ion conductivity. Typical positive electrode and negative electrode constitute an electrode body together with a separator interposed therebetween The electrode body is configured as, for example, a columnar wound body in which a band-shaped positive electrode and a band-shaped negative electrode are wound with a separator interposed therebetween. The electrode body may also be configured as a stacked body in which a plate-shaped positive electrode and a plate-shaped negative electrode are stacked with a separator interposed therebetween.

The negative electrode includes a negative current collector and a negative electrode material layer supported on the negative current collector. The negative electrode material layer contains a negative electrode active material capable of being reversibly doped with lithium ions. The negative electrode active material contains a carbon material.

In the carbon material, the Faraday reaction in which lithium ions are reversibly occluded and released proceeds to develop a capacitance. The meaning for the doping of the negative electrode active material with lithium ions includes at least an occlusion phenomenon of lithium ions into the negative electrode active material and may include adsorption of lithium ions to the negative electrode active material and chemical interaction between the negative electrode active material and lithium ions.

A surface layer portion of the negative electrode material layer includes a coating region. The coating region is a region where an SEI coating film is formed. The SEI coating film contains lithium carbonate (Li₂CO₃). The SEI coating film containing lithium carbonate has low resistance to migration of lithium ions, and can reduce the internal resistance of the electrochemical device by forming the SEI coating film containing lithium carbonate as a main component. On the other hand, the SEI coating film containing lithium carbonate as a main component easily reacts with HF generated by a decomposition reaction of the electrolytic solution or the like, and the SEI coating film is easily disintegrated.

The SEI coating film may contain lithium fluoride (LiF). The SEI coating film containing lithium fluoride is stable to an electrolytic solution and also has low reactivity with HF. However, the SEI coating film containing lithium fluoride as a main component has high resistance to lithium ion migration, and tends to have high internal resistance of the electrochemical device.

When the coating region containing lithium carbonate is measured by X-ray photoelectron spectroscopy (XPS), a peak attributed to a lithium carbonate bond is observed in an O1s spectrum. The peak attributed to a lithium carbonate bond is a peak attributed to the C═O bond (or C—O bond) of lithium carbonate, and may appear in a range from 530 eV to 534 eV of a binding energy.

On the other hand, when the coating region containing lithium fluoride is measured by X-ray photoelectron spectroscopy (XPS), a peak attributed to a lithium fluoride bond is observed in an F1s spectrum. The peak attributed to a lithium fluoride bond is a peak attributed to the Li—F, and may appear in a range from 684.8 eV to 685.3 eV of a binding energy.

In the electrochemical device according to an exemplary embodiment of the present invention, in the O1s spectrum, an intensity of the peak observed in a range from 530 eV to 534 eV of a binding energy increases from a surface layer of the coating region toward the inside of the coating region. This means that in the coating region, lithium carbonate is unevenly distributed to be present in a large amount in a central portion and a deep portion (negative electrode active material side) of the coating region in a depth direction, and the amount of lithium carbonate present in the surface layer of the coating region is reduced. As a result, contact of the SEI coating film containing a large amount of lithium carbonate with the electrolytic solution is regulated, and collapse of the SEI coating film is suppressed while the lithium ion migration resistance is maintained low.

On the other hand, in the F1s spectrum, an intensity of the peak observed in a range from 684.8 eV to 685.3 eV of a binding energy may decrease from the surface layer of the coating region toward the inside of the coating region in a depth region where the intensity of the peak attributed to the lithium carbonate bond in the O1s spectrum increases from the surface layer of the coating region toward the inside of the coating region. That is, the SEI coating film containing a large amount of lithium fluoride can be formed on the surface layer of the coating region in contact with the electrolytic solution. The SEI coating film containing a large amount of lithium fluoride is stable to an electrolytic solution, and the SEI coating film is hardly disintegrated. Since the SEI coating film containing a large amount of lithium carbonate is formed on the inner side, the thickness of the SEI coating film containing a large amount of lithium fluoride may be thin, and an increase in lithium ion migration resistance is suppressed.

In other words, the coating region includes a first layer formed on the surface layer in contact with the electrolytic solution and containing a large amount of lithium fluoride, and a second layer formed on the inside (the side in contact with the negative electrode active material) of the first layer and containing a large amount of lithium carbonate. A concentration (content rate per unit volume) of lithium fluoride in the first layer is larger than a concentration of lithium fluoride in the second layer. On the other hand, a concentration (content rate per unit volume) of lithium carbonate in the second layer is larger than a concentration of lithium carbonate in the first layer. However, it is not necessary that there is a clear difference in the concentration of lithium carbonate or lithium fluoride with the boundary between the first layer and the second layer as a boundary, and the concentration of lithium fluoride may gradually decrease from the first layer toward the second layer and/or the concentration of lithium carbonate may gradually increase from the first layer toward the second layer.

At any depth, the peak intensity at the apex of the peak in the O1s spectrum is designated as “A”, and the peak intensity at the apex of the peak in the F1s spectrum is designated as “B”. The distribution of the peak intensity B in the depth direction (the thickness direction of the surface layer portion) may have a maximum apex in the surface layer (first layer) of the coating region. On the other hand, in the distribution of the peak intensity A in the depth direction (the thickness direction of the surface layer portion), the peak intensity increases toward the negative electrode active material side in the surface layer of the coating region, and the peak intensity may have a maximum apex in the second layer on the inner side (the negative electrode active material side). In this case, a peak intensity ratio A/B increases from the surface layer toward the inside of the coating region, and then turns to decrease The peak intensity ratio A/B preferably takes a maximum value in the coating region. In this case, when the surface layer portion of the negative electrode material layer is measured by X-ray photoelectron spectroscopy, a peak attributed to the carbon material is not substantially observed in the C1s spectrum at a depth position where the peak intensity ratio A/B is maximum.

The peak attributed to the carbon material in the C1s spectrum is a peak attributed to the in-plane C—C bond of graphite, and may appear in a range from 281 eV to 283 eV of a binding energy. The phrase “the peak attributed to the carbon material is not substantially observed” means that the peak intensity at the apex of the peak is less than or equal to 0.2 times the peak intensity A.

The maximum value of the peak intensity ratio A/B in the depth direction is, for example, from 0.5 to 2, inclusive, and may be from 1 to 1.8, inclusive The peak intensities A and B are determined from the height of the peak from the baseline.

The layer (second layer) containing a large amount of lithium carbonate may be formed on the surface layer portion of the negative electrode material layer before assembly of the electrochemical device. In the electrochemical device assembled using the negative electrode, the first layer containing a large amount of lithium fluoride can be formed on the surface of the negative electrode active material to have a uniform and appropriate thickness with the second layer as an underlayer by subsequent charging and discharging. The first layer is formed, for example, by a reaction between an electrolyte and the negative electrode in the electrochemical device. The second layer containing lithium carbonate has an action of promoting formation of the first layer that is a favorable SEI coating film and maintaining the SEI coating film in a favorable state when charging and discharging are repeated.

The thickness of the first layer containing a large amount of lithium fluoride may be, for example, more than or equal to 1 nm or may be more than or equal to 3 nm. It is sufficient that the thickness thereof is more than or equal to 5 nm. When the thickness of the first layer exceeds 20 nm, the first layer itself may be a resistance component. Thus, the thickness of the first layer may be less than or equal to 20 nm or may be less than or equal to 10 nm.

On the other hand, the thickness of the second layer containing a large amount of lithium carbonate may be, for example, more than or equal to 1 nm, may be more than or equal to 5 nm when a longer-term action is expected, and may be more than or equal to 10 nm when a more reliable action is expected. When the thickness of the second layer exceeds 50 nm, the first layer itself may be a resistance component. Thus, the thickness of the second layer may be less than or equal to 50 nm or may be less than or equal to 30 nm. The thickness thereof is, for example, 1 nm to 50 nm.

The thickness of the coating region (the thicknesses of the first layer and the second layer) is measured by analyzing the surface layer portion of the negative electrode material layer at a plurality of locations (at least five locations) of the negative electrode material layer. Then, the average of the thickness of the first layer or second layer obtained at the plurality of locations may be set as the thickness of the first layer or second layer. The negative electrode material layer used as a measurement sample may be peeled off from the negative current collector. In this case, the coating film formed on the surface of the carbon material included in the vicinity of the surface layer portion of the negative electrode material layer may be analyzed. In this case, the carbon material covered with the coating film may be collected from the region of the negative electrode material layer formed on the surface reverse to the surface bonded to the negative current collector, and the collected carbon material may be analyzed.

In the case of the negative electrode extracted from the electrochemical device after being completed and subjected to predetermined aging or charged and discharged at least once, the surface layer portion of the negative electrode material layer or the coating film formed on the surface of the carbon material includes an SEI coating film (that is, the first layer) generated in the electrochemical device. In this case, in the O1s spectrum, a peak attributed to lithium carbonate can also be observed in the first layer. However, since the first layer generated in the electrochemical device has a composition different from that of the second layer which is formed in advance before assembly of the electrochemical device, it is possible to distinguish them. For example, in the XPS analysis of the first layer, an F1s peak attributed to the LiF bond is observed, but a substantial F1s peak attributed to the LiF bond is not observed in the second layer. In addition, the amount of lithium carbonate contained in the first layer is very small. As the peak of the Li1s spectrum, a peak derived from a compound such as ROCO₂Li or ROLi may be detected, for example.

When the coating region containing lithium carbonate is analyzed by the XPS, in the O1s spectrum, a peak (second peak) attributed to the Li—O bond may be observed in addition to a peak (first peak) attributed to the C═O bond. The region of the coating film present near the surface of the carbon material is considered to contain a small amount of LiOH or Li₂O.

Specifically, when the coating region is analyzed in the depth direction, in the O1s spectrum, a first region, in which the first peak (attributed to the C═O bond) and the second peak (attributed to the Li—O bond) are observed and a first peak intensity is larger than a second peak intensity, and a second region, in which the first peak and the second peak are observed and the second peak intensity is larger than the first peak intensity, may be observed in the order of decreasing the distance from the outermost surface of the surface layer portion. A third region where the first peak is observed and the second peak is not observed may further be present, the third region being located closer to the outermost surface of the surface layer portion than the first region. The third region is likely to be observed when the thickness of the second layer is large.

At the center in the thickness direction of the second layer, usually, the peak attributed to the C—C bond is not substantially observed in the C1s spectrum, or even when observed, the peak is half or less of the peak intensity attributed to the C═O bond.

The XPS analysis of the surface layer portion of the negative electrode material layer is carried out such that, for example, the surface layer portion or the coating film formed on the surface of the carbon material is irradiated with an argon beam in a chamber of an X-ray photoelectron spectrometer, and a variation in each spectrum attributed to C1s, O1s, or F1s electrons with respect to the irradiation time is observed and recorded. At this time, from the viewpoint of avoiding analysis error, the spectrum of the outermost surface of the surface layer portion may be ignored. The thickness of the region where the peak attributed to lithium fluoride is stably observed corresponds to the thickness of the first layer. The thickness of the region where the peak attributed to lithium carbonate is stably observed corresponds to the thickness of the second layer.

A method for forming a coating region on a surface layer portion of the negative electrode material layer will be described. First, the second layer containing lithium carbonate is formed on the surface layer portion of the negative electrode material layer. A step of forming the second layer may be performed by, for example, a gas phase method, a coating method, transfer, or the like.

Examples of the gas phase method include chemical vapor deposition, physical vapor deposition, and sputtering. For example, lithium carbonate may be attached to the surface of the negative electrode material layer with a vacuum vapor deposition apparatus. The pressure in a chamber of the apparatus during vapor deposition may be, for example, from 10⁻² Pa to 10⁻⁵ Pa, the temperature of a lithium carbonate evaporation source may be from 400° C. to 600° C., and the temperature of the negative electrode material layer may be from −20° C. to 80° C.

As the coating method, the second layer may be formed by coating a solution or dispersion containing lithium carbonate on a surface of the negative electrode using, for example, a microgravure coater and drying the solution or dispersion. The content of lithium carbonate in the solution or dispersion is, for example, 0.3 mass % to 2 mass %, and when a solution is used, the content of lithium carbonate may be a concentration equal to or lower than the solubility (for example, about 0.9 mass % to 1.3 mass % in the case of an aqueous solution at normal temperature).

Further, the negative electrode may be obtained by performing a step of forming the first layer containing lithium fluoride so as to cover at least a part of the second layer. The surface layer portion of the obtained negative electrode material layer has the first layer and the second layer. The first layer is formed such that at least a part of the first layer covers at least a part (preferably the whole) of the surface of the negative electrode active material with the second layer interposed therebetween (that is, the second layer is used as an underlayer).

Since the step of forming a first layer is performed in a state where the negative electrode material layer and the electrolyte are in contact with each other, the step may also serve as at least part of a step of pre-doping the negative electrode material layer with lithium ions. As a source of the lithium ions to be pre-doped, for example, metal lithium may be used.

Metal lithium may be attached to the surface of the negative electrode material layer. The second layer containing lithium carbonate having a thickness of, for example, from 1 nm to 50 nm, inclusive, can also be formed by exposing the negative electrode having the negative electrode material layer to which metal lithium is attached to a carbon dioxide gas atmosphere.

A step for depositing metal lithium to the surface of the negative electrode material layer can be performed by, for example, a gas phase method, transfer, or the like. Examples of the gas phase method include chemical vapor deposition, physical vapor deposition, and sputtering. For example, metal lithium may be formed into a film on the surface of the negative electrode material layer by a vacuum vapor deposition apparatus. The pressure in a chamber of the apparatus during vapor deposition may be, for example, 10⁻² Pa to 10⁻⁵ Pa, the temperature of a lithium evaporation source may be 400° C. to 600° C., and the temperature of the negative electrode mixture layer may be −20° C. to 80° C.

The carbon dioxide gas atmosphere is preferably a dry atmosphere that does not contain moisture and may have, for example, a dew point of less than or equal to −40° C. or less than or equal to −50° C. The carbon dioxide gas atmosphere may contain gases other than carbon dioxide, but the molar fraction of carbon dioxide is preferably more than or equal to 80%, more preferably more than or equal to 95%. It is desirable that the carbon dioxide gas atmosphere does not contain an oxidizing gas, and the molar fraction of oxygen may be less than or equal to 0.1%.

To form the second layer to be thicker, it is efficient that the partial pressure of carbon dioxide is made larger than, for example, 0.5 atm (5.05×10⁴ Pa), and may be more than or equal to 1 atm (1.01×10⁵ Pa).

The temperature of the negative electrode exposed to the carbon dioxide gas atmosphere may be, for example, in the range from 15° C. to 120° C. The higher the temperature, the thicker the second layer.

The thickness of the second layer may be easily controlled by changing the time for exposing the negative electrode to the carbon dioxide gas atmosphere. The exposure time may be, for example, more than or equal to 12 hours and less than 10 days.

It is desirable that the step of forming the second layer is performed before the electrode body is formed, but performing this step after the electrode body is formed is not excluded. That is, the second layer may be formed on the surface layer portion of the negative electrode material layer by preparing a positive electrode, preparing a negative electrode having a negative electrode material layer to which metal lithium is attached, forming an electrode body with a separator interposed between the positive electrode and the negative electrode, and exposing the electrode body to a carbon dioxide gas atmosphere.

The step of pre-doping the negative electrode material layer with lithium ions proceeds further by, for example, bringing the negative electrode material layer into contact with the electrolyte, and is completed after they are left for a predetermined time. Such a step may be a step of forming the first layer so as to cover at least a part of the second layer. For example, by charging and discharging the electrochemical device at least once, the first layer may be formed in the negative electrode material layer, and pre-doping of lithium ions to the negative electrode may be completed. For example, the pre-doping of the lithium ions to the negative electrode may also be completed by applying a predetermined charge voltage (for example, 3.4 V to 4.0 V) between the terminals of the positive electrode and the negative electrode for a predetermined time (for example, 1 hour to 75 hours).

The electrochemical device according to the present invention includes an electrochemical device such as a lithium ion secondary battery, a lithium ion capacitor, or an electric double layer capacitor. As the positive electrode of the electrochemical device, for example, a polarizable electrode layer may be configured using a positive electrode material layer containing a carbon material as a positive electrode active material. In this case, an electric double layer is formed by adsorption of ions to the positive electrode active material, and a capacitance is developed on the positive electrode side. The carbon material is, for example, activated carbon. As the carbon material (for example, activated carbon), a carbon material having a specific surface area of from 1500 m²/g to 2500 m²/g, inclusive, an average particle diameter of less than or equal to 10 μm, a total pore volume of from 0.5 cm³/g to 1.5 cm³/g, inclusive, and an average pore size of from 1 nm to 3 nm, inclusive, can be preferably used.

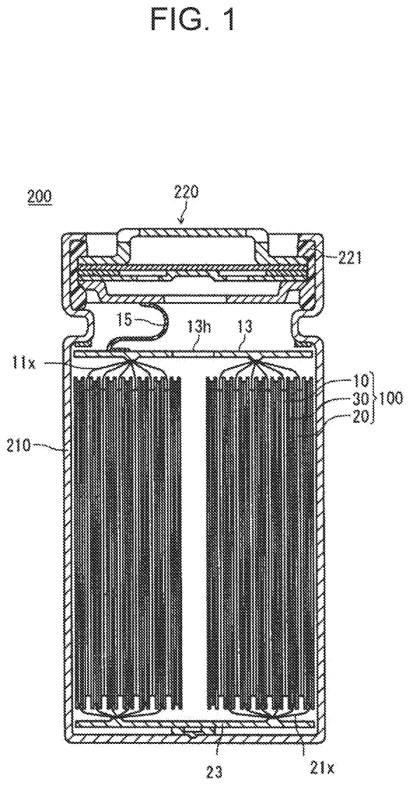

FIG. 1 schematically illustrates the configuration of electrochemical device 200 according to an exemplary embodiment of the present invention. Electrochemical device 200 includes electrode body 100, a nonaqueous electrolyte (not illustrated), bottomed cell case 210 made of metal, which accommodates electrode body 100 and the nonaqueous electrolyte, and sealing plate 220 that seals an opening of cell case 210. Gasket 221 is provided on the peripheral edge of sealing plate 220, and the open end of cell case 210 is crimped with gasket 221, whereby the inside of cell case 210 is sealed. Positive current collection plate 13 having through hole 13h in the center is welded to positive-electrode-core-material exposed part 11x. The other end of tab lead 15 having one end connected to positive current collection plate 13 is connected to an inner surface of sealing plate 220. Therefore, sealing plate 220 has a function as an external positive electrode terminal. On the other hand, negative current collection plate 23 is welded to negative-electrode-core-material exposed part 21x Negative current collection plate 23 is directly welded to a welding member provided on the inner bottom surface of cell case 210. Thus, cell case 210 has a function as an external negative electrode terminal.

Hereinafter, each component of the electrochemical device according to the exemplary embodiment of the present invention will be described in more detail.

### Negative Electrode

The negative electrode includes a negative current collector and a negative electrode material layer (negative electrode mixture layer) supported on the negative current collector.

A sheet-shaped metallic material is used as the negative current collector. The sheet-shaped metallic material may be a metal foil, a porous metal body, an etched metal, or the like. As the metallic material, copper, a copper alloy, nickel, stainless steel, or the like may be used.

The negative current collection plate is a metal plate having a substantially disk shape. The material of the negative current collection plate is, for example, copper, a copper alloy, nickel, stainless steel, or the like. The material of the negative current collection plate may be the same as the material of the negative current collector.

### Negative Electrode Material Layer

The negative electrode material layer includes a carbon material that electrochemically absorbs and releases lithium ions as a negative electrode active material. As the carbon material, graphite, non-graphitizable carbon (hard carbon), and graphitizing carbon (soft carbon) are preferable, and graphite and hard carbon are particularly preferable. A carbon material and other materials may be used in combination.

The non-graphitizable carbon may have an interplanar spacing d₀₀₂ (that is, the interplanar spacing between a carbon layer and a carbon layer) of the (002) plane of more than or equal to 3.8 Å as measured by an X-ray diffraction method. The theoretical capacity of the non-graphitizable carbon is desirably, for example, more than or equal to 150 mAh/g. By using non-graphitizable carbon, a negative electrode having a small low-temperature DCR and small expansion and contraction accompanying charging and discharging is likely to be obtained. The non-graphitizable carbon desirably accounts for more than or equal to 50% by mass, further, more than or equal to 80% by mass, and further, more than or equal to 95% by mass of the negative electrode active material. The non-graphitizable carbon desirably accounts for more than or equal to 40% by mass, further, more than or equal to 70% by mass, and further, more than or equal to 90% by mass of the negative electrode mixture layer.

As the negative electrode active material, non-graphitizable carbon and a material other than non-graphitizable carbon may be used in combination. Examples of the material other than non-graphitizable carbon that may be used as the negative electrode active material include graphitizable carbon (soft carbon), graphite (natural graphite, artificial graphite, and the like), lithium titanium oxide (spinel type lithium titanium oxide or the like), silicon oxide, silicon alloys, tin oxide, and tin alloys

The average particle diameter of the negative electrode active material (in particular, non-graphitizable carbon) is preferably in the range from 1 μm to 20 μm, inclusive, more preferably in the range from 2 μm to 15 μm, inclusive, from the viewpoint of a high filling property of the negative electrode active material in the negative electrode and easy inhibition of side reactions with the electrolyte.

In the present specification, the average particle diameter means a volume-based median diameter (D50) in a particle size distribution obtained by laser diffraction type particle size distribution measurement.

The negative electrode material layer contains a negative electrode active material as an essential component and contains a conductive material, a binding material, and the like as optional components. Examples of the conductive agent include carbon black and carbon fiber. Examples of the binding agent include a fluorine resin, an acrylic resin, a rubber material, and a cellulose derivative.

The negative electrode material layer is formed, for example, by mixing a negative electrode active material, a conductive agent, a binding agent, and the like together with a dispersion medium to prepare a negative electrode mixture slurry, applying the negative electrode mixture slurry to the negative current collector, and then drying the negative electrode mixture slurry. The thickness of the negative electrode material layer is, for example, 10 μm to 300 μm per surface.

The negative electrode material layer is pre-doped with lithium ions. This doping decreases the potential of the negative electrode and thus increases a difference in potential (that is, voltage) between the positive electrode and the negative electrode and improves energy density of the electrochemical device. The amount of lithium to be pre-doped may be, for example, about 50% to 95% of the maximum amount that can be absorbed in the negative electrode material layer.

### Positive Electrode

The positive electrode includes a positive current collector and a positive electrode material layer (positive electrode mixture layer) supported on the positive current collector.

A sheet-shaped metallic material is used as the positive current collector. The sheet-shaped metallic material may be a metal foil, a porous metal body, an etched metal, or the like. As the metallic material, aluminum, an aluminum alloy, nickel, titanium, or the like may be used.

The positive current collection plate is a metal plate having a substantially disk shape. It is preferable to form a through-hole serving as a passage for the nonaqueous electrolyte in the center of the positive current collection plate. The material of the positive current collection plate is, for example, aluminum, an aluminum alloy, titanium, stainless steel, or the like. The material of the positive current collection plate may be the same as the material of the positive current collector.

### Positive Electrode Material Layer

The positive electrode material layer contains a material capable of being reversibly doped with an anion as a positive electrode active material. The positive electrode active material is, for example, a carbon material, a conductive polymer, or the like.

As the carbon material used as the positive electrode active material, a porous carbon material is preferable For example, activated carbon or a carbon material exemplified as the negative electrode active material (for example, non-graphitizable carbon) is preferable. Examples of the raw material of activated carbon include wood, coconut shell, coal, pitch, and phenol resin. The activated carbon is preferably subjected to an activation treatment.

The average particle diameter of the carbon material (volume-based median diameter D50) is not particularly limited and is preferably less than or equal to 20 μm and more preferably less than or equal to 10 μm. The average particle diameter of the carbon material may be 3 μm to 10 μm.

The specific surface area of the positive electrode material layer roughly reflects the specific surface area of the positive electrode active material. The specific surface area of the positive electrode material layer is, for example, from 600 m²/g to 4,000 m²/g, inclusive, and is desirably from 800 m²/g to 3,000 m²/g, inclusive. The specific surface area of the positive electrode material layer may be more desirably from 1500 m²/g to 2500 m²/g, inclusive.

The specific surface area of the positive electrode mixture layer is a BET specific surface area determined using a measurement apparatus in accordance with JIS Z 8830 (for example, TriStar II 3020 manufactured by SHIMADZU CORPORATION). Specifically, the electrochemical device is disassembled, and the positive electrode is taken out. Next, the positive electrode is washed with dimethyl carbonate (DMC) and dried. Thereafter, the positive electrode mixture layer is peeled off from the positive current collector, and about 0.5 g of a sample of the positive electrode mixture layer is collected.

Next, the collected sample is heated at 150° C. for 12 hours under a reduced pressure of less than or equal to 95 kPa, and thereafter, nitrogen gas is adsorbed to the sample whose mass is known to obtain an adsorption isotherm at a relative pressure in the range from 0 to 1. Then, the surface area of the sample is calculated from the monolayer adsorption amount of the gas obtained from the adsorption isotherm. Here, the specific surface area is determined from the following BET formula by the single-point BET method (relative pressure 0.3).

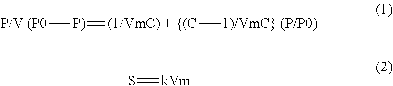

P0: saturated vapor pressure
P: adsorption equilibrium pressure
V: adsorption amount at adsorption equilibrium pressure P
Vm: monolayer adsorption amount
C: parameter related to adsorption heat and the like
S: specific surface area
k: occupancy area of nitrogen single molecule of 0.162 nm²

The activated carbon desirably accounts for more than or equal to 50% by mass, further, more than or equal to 80% by mass, and further, more than or equal to 95% by mass of the positive electrode active material. The activated carbon desirably accounts for more than or equal to 40% by mass, further, more than or equal to 70% by mass, and further, more than or equal to 90% by mass of the positive electrode material layer.

The positive electrode material layer contains a positive electrode active material as an essential component, and contains a conductive material, a binding material, and the like as optional components. Examples of the conductive agent include carbon black and carbon fiber. Examples of the binding agent include a fluorine resin, an acrylic resin, a rubber material, and a cellulose derivative.

The positive electrode material layer is formed by, for example, mixing the positive electrode active material, the conductive agent, the binding agent, and the like with a dispersion medium to prepare a positive electrode mixture slurry, applying the positive electrode mixture slurry to the positive current collector, and thereafter drying the positive electrode mixture slurry. The thickness of the positive electrode material layer is, for example, 10 μm to 300 μm per surface of the positive current collector.

The conductive polymer used as the positive electrode active material is preferably a x-conjugated polymer. As the x-conjugated polymer, for example, polypyrrole, polythiophene, polyfuran, polyaniline, poly(thiophene vinylene), polypyridine, or a derivative of these polymers may be used. These materials may be used alone or in combination of two or more kinds thereof. The weight-average molecular weight of the conductive polymer ranges, for example, from 1,000 to 100,000, inclusive. The derivative of the x-conjugated polymer means a polymer having, as a basic skeleton, a x-conjugated polymer such as polypyrrole, polythiophene, polyfuran, polyaniline, poly(thiophene vinylene), or polypyridine. For example, a polythiophene derivative includes poly(3,4-ethylenedioxythiophene) (PEDOT).

The conductive polymer is formed by, for example, immersing a positive current collector including a carbon layer in a reaction solution containing a raw material monomer of the conductive polymer, and electrolytically polymerizing the raw material monomer in the presence of the positive current collector. In the electrolytic polymerization, the positive current collector and a counter electrode may be immersed in a reaction solution containing a raw material monomer, and a current may be caused to flow between them with the positive current collector as an anode. The conductive polymer may be formed by a method other than electrolytic polymerization. For example, the conductive polymer may be formed by chemical polymerization of a raw material monomer. In the chemical polymerization, the raw material monomer may be polymerized with an oxidizing agent or the like in the presence of the positive current collector.

The raw material monomer used in electrolytic polymerization or chemical polymerization may be any polymerizable compound capable of producing the conductive polymer by polymerization. The raw material monomer may contain an oligomer. Examples of the raw material monomer that may be used include aniline, pyrrole, thiophene, furan, thiophene vinylene, pyridine, or a derivative of these monomers. These materials may be used alone or in combination of two or more kinds thereof. Among them, aniline is likely to grow on the surface of a carbon layer by electrolytic polymerization.

Electrolytic polymerization or chemical polymerization may be carried out using a reaction solution containing an anion (dopant). Excellent conductivity is exhibited by doping the x-electron conjugated polymer with a dopant. Examples of the dopant include a sulfate ion, a nitrate ion, a phosphate ion, a borate ion, a benzenesulfonate ion, a naphthalenesulfonate ion, a toluenesulfonate ion, a methanesulfonate ion, a perchlorate ion, a tetrafluoroborate ion, a hexafluorophosphate ion, and a fluorosulfate ion. The dopant may be a polymer ion. Examples of the polymer ion include ions of polyvinylsulfonic acid, polystyrenesulfonic acid, acid, polyallylsulfonic acid, polyacrylsulfonic polymethacrylsulfonic acid, poly(2-acrylamido-2-methylpropanesulfonic acid), polyisoprenesulfonic acid, and polyacrylic acid.

### Separator

As the separator, a nonwoven fabric made of cellulose fiber, a nonwoven fabric made of glass fiber, a microporous film, woven fabric, or nonwoven fabric made of polyolefin, or the like may be used. The thickness of the separator ranges, for example, from 8 μm to 300 μm, inclusive, and preferably range from 8 μm to 40 μm, inclusive

### Electrolyte

The electrolyte has lithium ion conductivity and contains a lithium salt and a solvent that dissolves the lithium salt. The lithium salt anion is repeatedly reversibly doped into and dedoped from the positive electrode. Lithium ions derived from the lithium salt are reversibly occluded in and released from the negative electrode.

Examples of the lithium salt include LiClO₄, LiBF₄, LiPF₆, LiAlCI₄, LiSbF₆, LiSCN, LiCF₃SO₃, LiFSO₃, LiCF₃CO₂, LiAsF₆, LiB₁₀Cl₁₀, LiCl, LiBr, LiI, LiBCl₄, LiN(SO₂F)₂, and LIN(SO₂CF₃)₂. These materials may be used alone or in combination of two or more kinds thereof. The lithium salt is preferably a salt having a fluorine-containing anion from the viewpoint of having a high degree of dissociation, obtaining an electrolytic solution having a low viscosity, and improving the withstand voltage characteristics of the electrochemical device.

The electrolyte preferably contains an imide-based electrolyte. The imide-based electrolyte contains an imide-based anion as an anion of a lithium salt. The imide-based anion may be an anion containing fluorine and sulfur, and in particular, it is preferable to use lithium bis(fluorosulfonyl)imide, that is, LiN(SO₂F)₂(LiFSI). For example, more than or equal to 80% by mass of the lithium salt may be LiFSI.

It is considered that LiFSI has an effect of reducing deterioration of the positive electrode active material and the negative electrode active material. Among salts having a fluorine-containing anion, the FSI anion is considered to be excellent in stability, so that it is less likely to generate by-products but smoothly contribute to charging and discharging without damaging the surface of the active materials. The SEI coating film formed on the surface layer portion of the negative electrode material layer by LiFSI contains a large amount of lithium fluoride and has a small content ratio of lithium carbonate. Thereby, a stable coating film (first layer) containing lithium fluoride as a main component can be formed to cover the second layer containing lithium carbonate as a main component.

The concentration of the lithium salt in the nonaqueous electrolyte in a charged state (charging rate (SOC) of 90% to 100%) ranges, for example, from 0.2 mol/L to 5 mol/L, inclusive.

Examples of the solvent that may be used include: cyclic carbonates such as ethylene carbonate, propylene carbonate, and butylene carbonate; chain carbonates such as dimethyl carbonate, diethyl carbonate, and ethyl methyl carbonate; aliphatic carboxylate esters such as methyl formate, methyl acetate, methyl propionate, and ethyl propionate; lactones such as γ-butyrolactone and γ-valerolactone; chain ethers such as 1,2-dimethoxyethane (DME), 1,2-diethoxyethane (DEE), and ethoxymethoxyethane (EME); cyclic ethers such as tetrahydrofuran and 2-methyltetrahydrofuran; dimethyl sulfoxide; 1,3-dioxolane; formamide; acetamide; dimethylformamide; dioxolane; acetonitrile; propionitrile; nitromethane; ethylmonoglyme; trimethoxymethane; sulfolane; methylsulfolane; and 1,3-propane sultone. These materials may be used alone or in combination of two or more kinds thereof.

The electrolyte may contain various additive agents as necessary. For example, an unsaturated carbonate such as vinylene carbonate, vinylethylene carbonate, and divinylethylene carbonate may be added as an additive agent for forming a coating film having lithium ion conductivity on the surface of the negative electrode.

### EXAMPLES

Hereinafter, the present invention will be described in more detail by way of examples, but the present invention is not limited to examples.

### Example 1

### (1) Production of Positive Electrode

An aluminum foil (positive current collector) having a thickness of 30 μm was prepared. Activated carbon (average particle diameter: 5.5 μm) in an amount of 88 parts by mass as a positive electrode active material, 6 parts by mass of polytetrafluoroethylene as a binding material, and 6 parts by mass of acetylene black as a conductive material were dispersed in water to prepare a positive electrode mixture slurry. The obtained positive electrode mixture slurry was applied to both surfaces of the aluminum foil, the coating film was dried, and the obtained material was rolled to form a positive electrode material layer, whereby a positive electrode was obtained. A positive current collector exposed part having a width of 10 mm was formed at an end part along a longitudinal direction of the positive current collector.

### (2) Production of Negative Electrode

A copper foil (negative current collector) having a thickness of 10 μm was prepared. Non-graphitizable carbon (average particle diameter: 5 μm) in an amount of 97 parts by mass, 1 part by mass of carboxycellulose, and 2 parts by mass of styrene-butadiene rubber were dispersed in water to prepare a negative electrode mixture slurry. The obtained negative electrode mixture slurry was applied to both surfaces of the copper foil, the coating film was dried, and the obtained material was rolled to form a negative electrode material layer, whereby a negative electrode was obtained.

Thereafter, a thin film of metal lithium for pre-doping was formed on the entire surface of the negative electrode mixture layer by vacuum vapor deposition. The amount of lithium to be pre-doped was set such that the negative electrode potential in a nonaqueous electrolyte after the completion of pre-doping was less than or equal to 0.2 V with respect to metal lithium.

Thereafter, the inside of the chamber of the apparatus was purged with carbon dioxide to form a carbon dioxide gas atmosphere, whereby a coating film (second layer) containing lithium carbonate on the surface layer portion of the negative electrode mixture layer was formed. The dew point of the carbon dioxide gas atmosphere was −40° C., the molar fraction of carbon dioxide was 100%, and the pressure inside the chamber was 1 atm (1.01×10⁵ Pa). The temperature of the negative electrode exposed to the carbon dioxide gas atmosphere of 1 atm was set to 25° C. The time for exposing the negative electrode to the carbon dioxide gas atmosphere was set to 22 hours.

### (3) Production of Electrode Body

The positive electrode and the negative electrode were wound in a columnar shape with a cellulose non-woven fabric separator (with a thickness 35 μm) therebetween to form an electrode body. During this process, the positive-electrode-core-material exposed part was projected from one end face of the wound body, and the negative-electrode-core-material exposed part was projected from the other end face of the electrode body. A positive current collection plate and a negative current collection plate, both of which had a disk shape, were welded to the positive-electrode-core-material exposed part and the negative-electrode-core-material exposed part, respectively.

### (4) Preparation of Nonaqueous Electrolytic Solution

A solvent was prepared by adding 0.2% by mass of vinylene carbonate to a mixture of propylene carbonate and dimethyl carbonate in a volume ratio of 1:1. LiFSI was dissolved as a lithium salt in the obtained solvent at a concentration of 1.2 mol/L to prepare a nonaqueous electrolyte.

### (5) Assembly of Electrochemical Device

The electrode body was housed in a bottomed cell case with an opening, the tab lead connected to the positive current collection plate was connected to the inner surface of the sealing plate, and the negative current collection plate was welded to the inner bottom surface of the cell case. The nonaqueous electrolyte was put into the cell case, and then, the opening of the cell case was closed with the sealing plate. An electrochemical device A1 as illustrated in FIG. 1 was thus assembled.

Thereafter, aging was performed at 60° C. while a charge voltage of 3.8 V was applied between terminals of the positive electrode and the negative electrode to complete pre-doping of the negative electrode with lithium ions.

### (6) Evaluation

### Evaluation 1

### XPS Analysis of Coating Region

The negative electrode was taken out from the electrochemical device, and the surface layer portion of the negative electrode material layer was analyzed for C1s spectrum, O1s spectrum, and F1s spectrum by XPS. An X-ray photoelectron spectrometer (product name: PHI Quantera SXM, manufactured by ULVAC-PHI, Inc.) was used for the analysis. The measurement conditions are as follows.

X-ray source: A1-mono (1486.6 eV) 15 kV/25 W
Measurement diameter: 100 μmφ
Photoelectron extraction angle: 45°
Etching conditions: accelerating voltage 2 kV, etching rate about 7.05 nm/min (in terms of SiO₂), raster area 2 mm×2 mm

### Evaluation 2

### Measurement of Internal Resistance of Electrochemical Device

The electrochemical device immediately after aging was subjected to constant current charging at a current density of 2 mA/cm² per positive electrode area under an environment of −30° C. until the voltage reached 3.8 V, and then a state in which the voltage of 3.8 V was applied was maintained for 10 minutes. Thereafter, under an environment of −30° C., constant current discharging was performed at a current density of 2 mA/cm² per positive electrode area until the voltage reached 2.2 V

Using a discharge curve (vertical axis: discharge voltage, horizontal axis: discharge time) obtained by the above discharge, a linear approximate line of the discharge curve in the range from 0.5 seconds to 2 seconds after the start of discharge was obtained, and a voltage VS of the intercept of the linear approximate line was determined. A value (V0−VS) obtained by subtracting voltage VS from voltage V0 at the start of discharging (when 0 second has elapsed from the start of discharging) was obtained as ΔV. Internal resistance (DCR) R1 (Ω) of the electrochemical device was determined from Formula (A) shown below using ΔV (V) and a current value (current density per positive electrode area: 2 mA/cm²×positive electrode area) Id at the time of discharging.

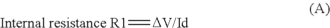

### Comparative Example 1

In the production of the negative electrode, a copper foil (negative current collector) having a thickness of 10 μm was prepared. Non-graphitizable carbon (average particle diameter: 5 μm) in an amount of 97 parts by mass, 1 part by mass of carboxycellulose, and 2 parts by mass of styrene-butadiene rubber were dispersed in water to prepare a negative electrode mixture slurry. The obtained negative electrode mixture slurry was applied to both surfaces of the copper foil, the coating film was dried, and the obtained material was rolled to form a negative electrode material layer, whereby a negative electrode was obtained.

Next, to the negative electrode material layer, was bonded a metal lithium foil in an amount calculated so that a negative electrode potential in the nonaqueous electrolyte after completion of pre-doping is less than or equal to 0.2 V with respect to metal lithium. The positive electrode and the negative electrode to which the metal lithium foil was bonded were wound in a columnar shape with a cellulose non-woven fabric separator (with a thickness 35 μm) therebetween to form an electrode body.

An electrochemical device B1 was produced in the same manner as in Example except for the above, and the electrochemical device was evaluated in the same manner as in Example.

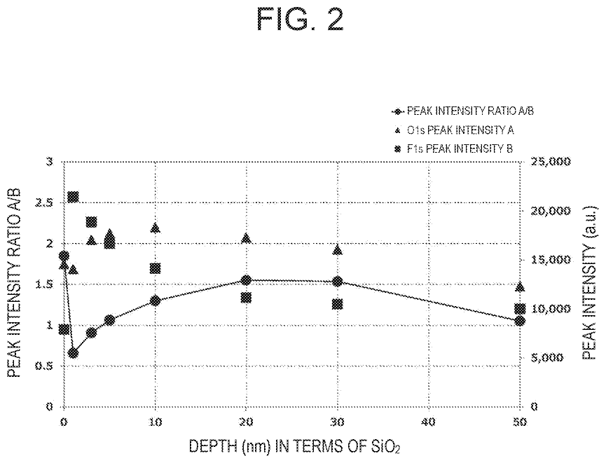

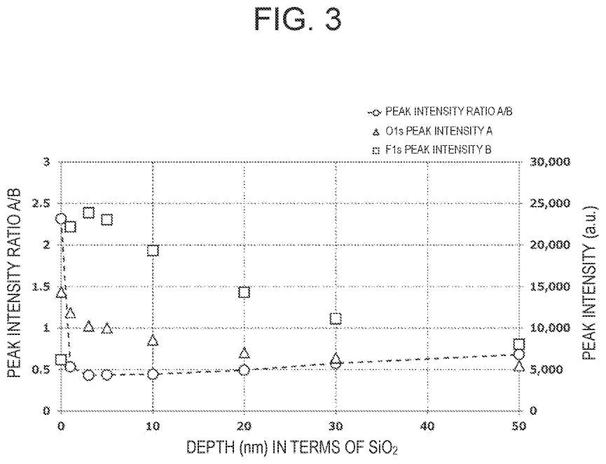

In the XPS analysis of the coating region, the peak intensity A at the apex of the peak appearing in a range from 530 eV to 534 eV of a binding energy was determined from the O1s spectrum as the intensity of the peak attributed to the lithium carbonate bond. The peak intensity B at the apex of the peak appearing in a range from 684.8 eV to 685.3 eV of a binding energy was determined from the F1s spectrum as the intensity of the peak attributed to the lithium fluoride bond. Changes in the peak intensity A, the peak intensity B, and the peak intensity ratio A/B in the depth direction (the thickness direction of the surface layer portion) were measured while the surface layer portion of the negative electrode material layer was etched. FIG. 2 shows changes in the peak intensity A, the peak intensity B, and the peak intensity ratio A/B in the depth direction in the electrochemical device A1. FIG. 3 shows changes in the peak intensity A, the peak intensity B, and the peak intensity ratio A/B in the depth direction in the electrochemical device B1.

From FIG. 2, in the electrochemical device A1 of Example 1, the peak intensity A (marked with ▴ in FIG. 2) attributed to the lithium carbonate bond in the O1s spectrum increases from the surface layer toward the inside (negative electrode active material side) of the coating region, and decreases after reaching a maximum value at a depth of 10 nm in terms of SiO₂. On the other hand, the peak intensity B (marked with ▪ in FIG. 2) attributed to the lithium fluoride bond in the F1s spectrum decreases from the surface layer toward the inside (negative electrode active material side) of the coating region. This means that the SEI coating film is formed such that the coating film (second layer) containing a large amount of lithium fluoride covers the coating film (first layer) containing a large amount of lithium carbonate. The peak intensity ratio A/B (marked with ● in FIG. 2) is about 1.55 at a depth of about 20 nm in terms of SiO₂, and takes a maximum value.

In the electrochemical device A1, a peak derived from the carbon material as the negative electrode active material was observed in the C1s spectrum from a depth of 50 nm in terms of SiO₂. Therefore, the thickness of the SEI coating film was evaluated to be 50 nm in terms of SiO₂.

On the other hand, from FIG. 3, in the electrochemical device B1 of Comparative Example 1, the peak intensity A (marked with A in FIG. 3) attributed to the lithium carbonate bond in the O1s spectrum decreases from the surface layer toward the inside (negative electrode active material side) of the coating region. On the other hand, the peak intensity B (marked with □ in FIG. 3) attributed to the lithium fluoride bond in the F1s spectrum increases and then decreases from the surface layer toward the inside (negative electrode active material side) of the coating region. In the peak intensity ratio A/B (marked with ○ in FIG. 3), no maximum value was observed due to a change in the depth direction.

In the electrochemical device B1, a peak derived from the carbon material as the negative electrode active material was observed in the C1s spectrum from a depth of 20 nm in terms of SiO₂. Therefore, the thickness of the SEI coating film was evaluated to be 20 nm in terms of SiO₂.

The internal resistance (DCR) of the electrochemical device A1 was 73 when the internal resistance (DCR) of the electrochemical device B1 was 100, and was remarkably reduced. The reason for this is considered to be that in the electrochemical device B1, since a large amount of lithium carbonate is contained in the surface layer of the coating region, the SEI coating film is easily disintegrated, whereas in the electrochemical device A1, since the content ratio of lithium carbonate contained in the surface layer of the coating region is reduced, and a large amount of lithium fluoride is contained in the surface layer of the coating region, an SEI coating film stable with respect to the electrolytic solution is formed. It is considered that a low-resistance coating film containing a large amount of lithium carbonate was formed inside the coating region, and a coating film containing a large amount of lithium fluoride was formed to cover the low-resistance coating film, so that the lithium ion migration resistance was reduced.

### INDUSTRIAL APPLICABILITY

The electrochemical device according to the present invention is suitable for, for example, in-vehicle use.

### REFERENCE MARKS IN THE DRAWINGS

100 electrode body
10 positive electrode
11x positive-electrode-core-material exposed part
13 positive current collection plate
15 tab lead
20 negative electrode
21x negative-electrode-core-material exposed part
23 negative current collection plate
30 separator
200 electrochemical device
210 cell case
220 sealing plate
221 gasket

1. An electrochemical device comprising:
a positive electrode;
a negative electrode; and
an electrolyte having lithium ion conductivity, wherein:
the negative electrode includes a negative current collector and a negative electrode material layer supported on the negative current collector,
the negative electrode material layer contains a negative electrode active material capable of being reversibly doped with lithium ions,
the negative electrode active material contains a carbon material,
the negative electrode material layer includes a coating region on a surface layer portion of the negative electrode material layer,
an O1s spectrum for the coating region has a peak in a range from 530 eV to 534 eV of a binding energy, the O1s spectrum being measured by X-ray photoelectron spectroscopy, and
an intensity of the peak in the O1s spectrum increases position changes from a surface layer of the coating region toward inside of the coating region.

2. The electrochemical device according to claim 1, wherein:
an F1s spectrum for the coating region has a peak in a range from 684.8 eV to 685.3 eV of a binding energy the F1s spectrum being measured by X-ray photoelectron spectroscopy, and
an intensity of the peak in the F1s spectrum decreases as a measuring position changes from the surface layer of the coating region toward the inside of the coating region.

3. The electrochemical device according to claim 2, wherein:
a ratio A/B of a peak intensity A to a peak intensity B increases and then decreases as a measuring position changes from the surface layer of the coating region toward the inside of the coating region, the peak intensity A being at an apex of the peak in the O1s spectrum, the peak intensity B being at an apex of the peak in the F1s spectrum, and
a C1s spectrum for the surface layer portion of the negative electrode material layer has substantially no peak attributed to a bond of the carbon material at a depth from the surface layer of the coating region where the ratio A/B is maximum, the C1s spectrum being measured by X-ray photoelectron spectroscopy.

4. The electrochemical device according to claim 1, wherein the electrolyte contains an imide-based electrolyte.

5. The electrochemical device according to claim 4, wherein the imide-based electrolyte contains an anion containing fluorine and sulfur.

6. The electrochemical device according to claim 1, wherein:
the positive electrode includes a positive current collector and a positive electrode material layer supported on the positive current collector, and
the positive electrode material layer contains a carbon material as a positive electrode active material and constitutes a polarizable electrode layer.

7. The electrochemical device according to claim 6, wherein;
a specific surface area of the carbon material contained in the positive electrode material ranges from 1500 m²/g to 2500 m²/g, inclusive,
an average particle diameter of the carbon material contained in the positive electrode material is less than or equal to 10 μm,
a total pore volume of the carbon material contained in the positive electrode material ranges from 0.5 cm³/g to 1.5 cm³/g. inclusive, and
an average pore size of the carbon material contained in the positive electrode material ranges from 1 nm to 3 nm, inclusive.
